(19) United States
(12) Patent Application Publication
(10) Pub. No.: US 2016/0036757 A1
(43) Pub. Date: Feb. 4, 2016

(54) METHOD AND SYSTEM FOR ALLOWING INDIVIDUALS TO QUICKLY AND EASILY SHARE THEIR BEHAVIORS OR ACTIONS ON A SOCIAL NETWORK

(71) Applicant: myActions, LLC, Cincinnati, OH (US)

(72) Inventors: Craig S. Young, Cincinnati, OH (US); James D. Young, Cincinnati, OH (US)

(21) Appl. No.: 14/816,765

(22) Filed: Aug. 3, 2015

Related U.S. Application Data
(60) Provisional application No. 62/032,180, filed on Aug. 1, 2014.

(51) Int. Cl. H04L 12/58

(52) U.S. Cl. CPC H04L 51/32

(57) ABSTRACT

A system for allowing an individual to share at least one behavior or action on a social network, the system comprising: a token comprising token data relating to the identification of the token and the social network so that at least one behavior or action can be shared on the social network; and a reader for receiving the token data from the token and for transferring the token data to a social network.

### REFERENCE TO PENDING PRIOR PATENT APPLICATION

This patent application claims benefit of pending prior U.S. Provisional Patent Application Ser. No. 62/032,180, filed Aug. 1, 2014 by myActions, LLC and Craig S. Young et al. for METHOD AND SYSTEM FOR THE IMPLEMENTATION OF IDENTIFICATION DEVICES TO BE USED WITH ENTERING DATA FOR SOCIAL NETWORKS (Attorney's Docket No. YOUNG-1 PROV), which patent application is hereby incorporated herein by reference.

### FIELD OF THE INVENTION

This invention relates to individuals and their behaviors or actions in general, and more particularly to methods and systems for allowing individuals to share their behaviors or actions with others. Among other things, this invention relates to methods and systems designed to make tracking, sharing and most significantly modifying the individuals' behaviors or actions easy, fun and worthwhile.

### BACKGROUND OF THE INVENTION

We have discovered that it is possible to use a social network to track and improve an individual's behaviors or actions including, but not limited to, environmental, social, personal, health, philanthropic and/or community behaviors or actions. The goal is to make it quick and easy for the individual to input the data about their behaviors or actions when and where they are engaging in those behaviors or actions. By way of example but not limitation, in the case of recycling a beverage container, the goal is to make it quick and easy for an individual to record their recycling activity at the time and place where they recycle the beverage container, and then to automatically share this activity with others on a social network so as to encourage other individuals to behave or act in a similar manner. By way of further example but not limitation, significant behaviors and actions can include carpooling to reduce CO2, recycling other objects or materials, reusing objects or materials, reducing use or waste, saving energy, reducing energy, helping others, volunteering, mentoring, complying with medical prescriptions, following up on physical therapy, exercising, making healthier food choices, donating, sharing information, signing petitions, organizing or attending benefit events for a cause, recognizing other individuals' good behaviors and actions, etc.

Our first attempt was to create a social network on the Internet as a website. This works well, however, the individual must “log in” to the social network at their computer and enter the information about their behaviors or actions after they have performed the behaviors or actions. See FIG. 1. We have found that the time delay between performing the behavior or taking the action, and then inputting the data at their computer, can reduce the individual's participation. Furthermore, if the individual performs the behavior or takes the action at one time and at one location, and then inputs data about their behavior or action from their computer at another time and at another location, there is a temporal and proximity “disconnect” between the time and location when the behavior or action are acted upon and the time and location of logging the behavior or action, and this can lead to data inaccuracies.

To address this issue, we next created a mobile website and a software application for smartphones (i.e., a cellular telephone with Internet capability) so that individuals could input the information about their behaviors or actions from their smartphones when and where the individual was actually performing the behavior or taking the action. See FIG. 2. This approach is an improvement over our aforementioned computer “log in” approach but has the requirement that the individual have a smartphone and Internet connectivity. Smartphones and Internet connectivity can be expensive and not everyone wants, has or can afford this technology.

While providing our aforementioned “log in” tool and our aforementioned “smartphone” tool, it was determined that many organizations are trying to track and improve people's behaviors or actions in many areas. By way of example but not limitation, zoos and aquariums play an important role in educating the public about the issues facing animals and the environment, and they look for ways to promote better behaviors or actions within the community. Companies are frequently looking for ways to improve their employees' behaviors or actions in areas including, but not limited to, energy saving, recycling, environmental matters, social matters, and/or health matters. Healthcare organizations, in addition to what has been stated above, look for ways to improve patient compliance. Other organizations are also trying to improve people's behaviors or actions.

While our aforementioned “log in” tool and our aforementioned “smartphone” tool are viable means for an individual to share their behaviors or actions on a social network, the limitation of needing a computer for our aforementioned “log in” tool, or the limitation of needing a smartphone for our aforementioned “smartphone” tool, have hindered the ability to inexpensively and effectively promote positive behaviors or actions throughout the community.

### SUMMARY OF THE INVENTION

The present invention comprises the provision and use of a novel method and system (hardware and software) for allowing individuals to quickly and easily share their behaviors or actions on a social network. The system uses a token that contains data such as, but not limited to, a unique token ID (for token identification), website address or identifier (for identifying the social network which is to receive the behaviors or actions of the individuals), optionally company ID, and/or optionally predefined actions. The token can communicate with a reader. The reader acquires (from the token) the data which is to be tracked on a social network, whereby to allow the individual to quickly and easily record their current behavior(s) or action(s) on the associated reader. The reader uses a communication scheme to transfer the token data to the appropriate social network, so that the individual's behaviors or actions can be shared with others. Preferably the reader can include location data to verify where the behavior or action was logged at the reader (and hence presumably performed), thereby providing vital location information on behavior change in the community. The reader location may be provided by any of several means, e.g., GPS data, Wi-Fi triangulation, and/or a reader ID and a reader location database (to show the location of the reader identified by the reader ID). Feedback may be presented to the individual and/or others at the reader, on separate displays, on a website, or by other means.

The present invention allows individuals to enter and share their behaviors or actions quickly, remotely, and at little or no cost to the individual.

The use of tokens with reading devices (readers) allows zoos, corporations, and other organizations to provide the means for people to track their environmental/social/health/etc. behaviors or actions at little or no cost to the individuals, further enhancing their behavior or action changes and bringing the message of their behaviors or actions into the community. Furthermore, by providing individuals with a quick and easy means for entering their behaviors or actions (since the individual does not need to “log in” at a computer or use their smartphone to access an Internet site), the present invention does not take time away from their productivity at work or cost them time when they are otherwise busy or enjoying themselves.

The combination of a token and a reader allows for data input to occur at places where the use of a computer or smartphone may not be appropriate, e.g., at schools, hospitals, theaters, churches, or any other place where those technologies would be considered disruptive.

Furthermore, children in grades K-12 are typically not allowed to use cellular telephones at school and generally have limited computer and Internet access at school. The tokens and readers can be utilized with a COPPA (Children's Online Privacy Protection Act) compliant version of the social network. This allows children under 13 years of age to participate. Additionally, the system can save money for the schools as children recycle, reduce, and modify other behaviors or actions that are beneficial to the individual and the community.

Additionally, the present invention allows organizations to track their effect on modifying environmental/social behaviors or actions outside of their organization, in the community and anywhere that the readers are placed around the country or the world.

In one preferred form of the invention, there is provided a system for allowing an individual to share at least one behavior or action on a social network, said system comprising:

a token comprising token data relating to the identification of the token and the social network so that at least one behavior or action can be shared on the social network; and

a reader for receiving said token data from said token and for transferring said token data to a social network.

In another preferred form of the invention, there is provided a method for allowing an individual to share at least one behavior or action on a social network, said method comprising:

providing a system comprising:
a token comprising token data relating to identification of the token and social network so that at least one behavior or action can be shared on a social network; and
a reader for receiving said token data from said token and for transferring said token data to a social network;

performing at least one behavior or action by the individual;

presenting the token to the reader so that the token data is received by the reader; and

transferring said token data from the reader to a social network.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing our aforementioned “log in” tool for allowing individuals to quickly and easily share their behaviors or actions on a social network;

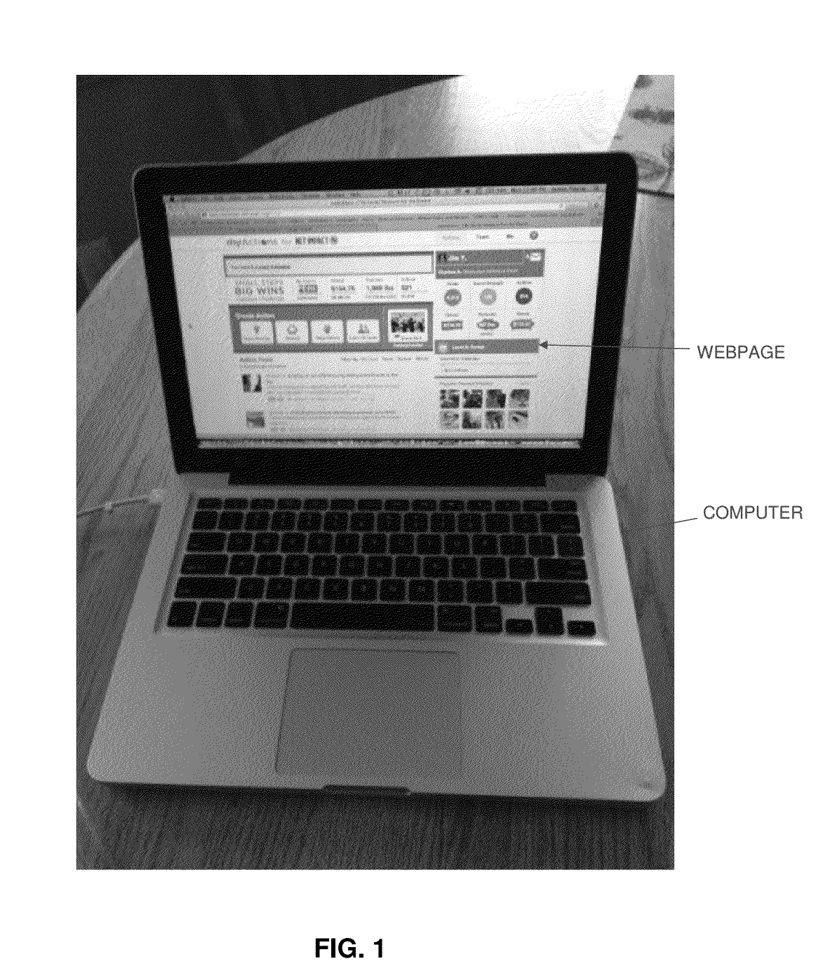

FIG. 2 is a schematic view showing our aforementioned “smartphone” tool for allowing individuals to quickly and easily share their behaviors or actions on a social network;

FIG. 2A is a schematic view showing a novel method and system (hardware and software) for allowing individuals to quickly and easily share their behaviors or actions on a social network;

FIG. 3 is a schematic view showing a bracelet-type token which may be used in connection with the present invention;

FIG. 4 is a schematic view showing how a reader may store token data locally on the reader until the token data is collected and sent to the host (e.g., the social network);

FIG. 5 is a schematic view showing how the reader can communicate directly to the host (e.g., the social network) and the host can, optionally, communicate directly to the reader;

FIG. 6 is a schematic view showing how the reader can communicate to a router that can use the token ID/data to direct the information to the appropriate host (e.g., the appropriate social network), and the host can, optionally, communicate to the reader through the router;

FIG. 7 is a schematic view showing how the reader can communicate to the router, which uses the token ID/data to reply to the reader to tell the reader which host (e.g., the appropriate social network) to communicate with;

FIG. 8 is a schematic view showing how the reader can store the token data, and a data transfer device can read the token data from the reader at key times or at the end of the day and the data transfer device can then transfer the data to the host (e.g., the social network);

FIG. 9 is a schematic view of an exemplary tablet reader that has been modified with an external antennae;

FIG. 10 is a schematic view showing an individual scanning a bracelet-type token near a recycling bin; and

FIG. 11 is a schematic view showing a close-up of an exemplary user interface for a reader.

### DETAILED DESCRIPTION OF THE INVENTION

The present invention comprises the provision and use of a novel method and system (hardware and software) for allowing individuals to quickly and easily share their behaviors or actions on a social network.

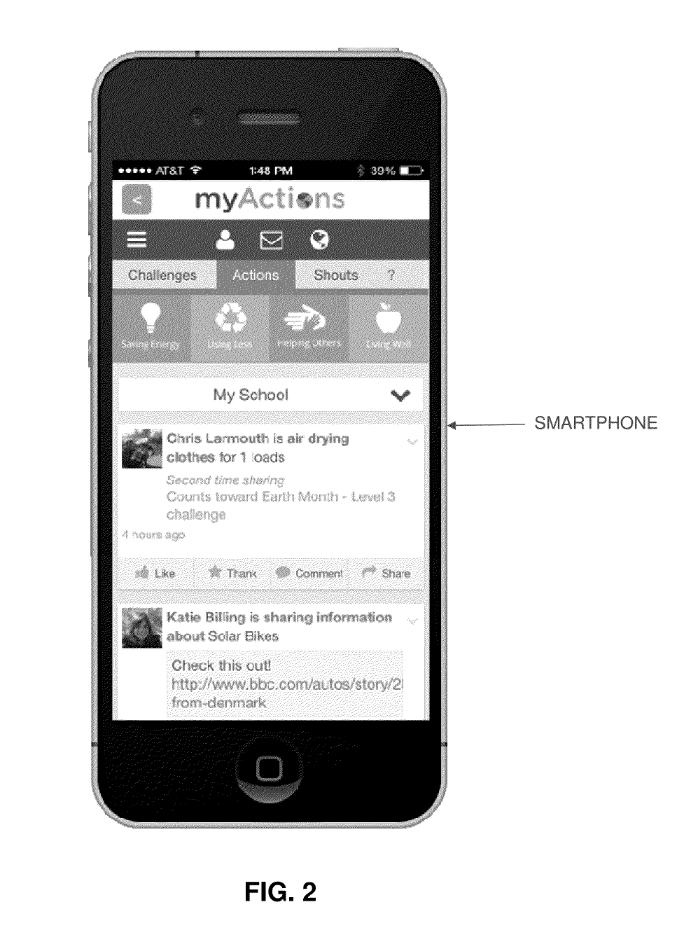

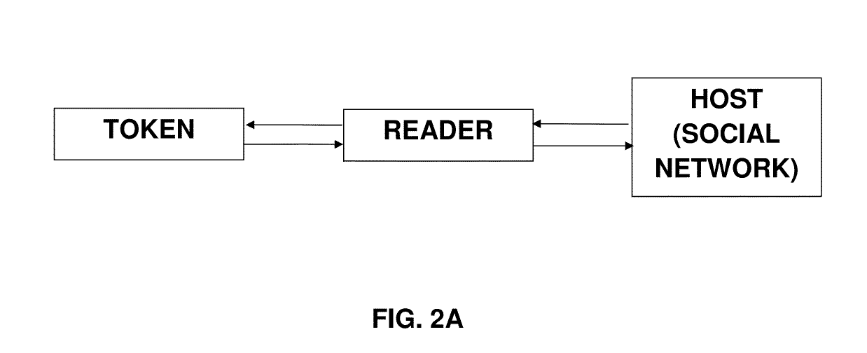

More particularly, the system preferably comprises three components for quickly and efficiently entering data into social networks. As seen in FIG. 2A, these three components comprise:

1. A token containing data relevant to the individual and/or social network.

2. A reader that reads the token data from the token. The reader can use that token data as is and/or optionally collect more data from the individual. The reader can, optionally, provide its location, with the reader location being provided by any of several means, e.g., via GPS data, Wi-Fi triangulation, and/or a reader ID coupled with a reader location database (to show the location of the reader identified by the reader ID).

3. A communication scheme for the reader to communicate with a host system or systems (e.g., a social network or social networks), one-way or bi-directionally.

The system preferably further comprises a fourth component:

4. A scheme for providing feedback to the individual or to others at the reader, or on a remote display, or on a website, or by other means.

### 1. A Token Containing Data Relevant to the Individual and/or Social Network

The system preferably uses a token that contains data such as, but not limited to, a unique token ID (for token identification), a website address or identifier (for identifying the social network which is to receive the behaviors or actions of the individuals), optionally a company ID, and/or optionally predefined actions. The token can communicate with a reader so as to pass token data to the reader. The invention is not limited to the type of token used, which may include a bracelet, a badge (supported on a neck lanyard or pocket/belt clip, etc.), etc., and which may include RFID (Radio Frequency Identification) devices (e.g., LF, UHF, short range, long range, passive, active, or other technologies), barcodes, QR codes, individual IDs, or other wireless communication (e.g., Bluetooth). Each type of token has advantages and disadvantages. Thus, with the present invention, the token can comprise an active element which transmits token data to an appropriate reader module at the reader (e.g., the token can comprise a wireless communication module which transmits token data to an electronic receiver module at the reader), or the token can comprise a passive element which presents token data to an appropriate reader module at the reader (e.g., the token can comprise a barcode display, a QR code display, an alphanumeric display, etc. which presents token data to an appropriate optical scanner module at the reader, or the token can comprise a passive RFID chip which presents token data to an appropriate RFID reader module at the reader, etc.). Such elements and modules will be apparent to those skilled in the art in view of the present disclosure.

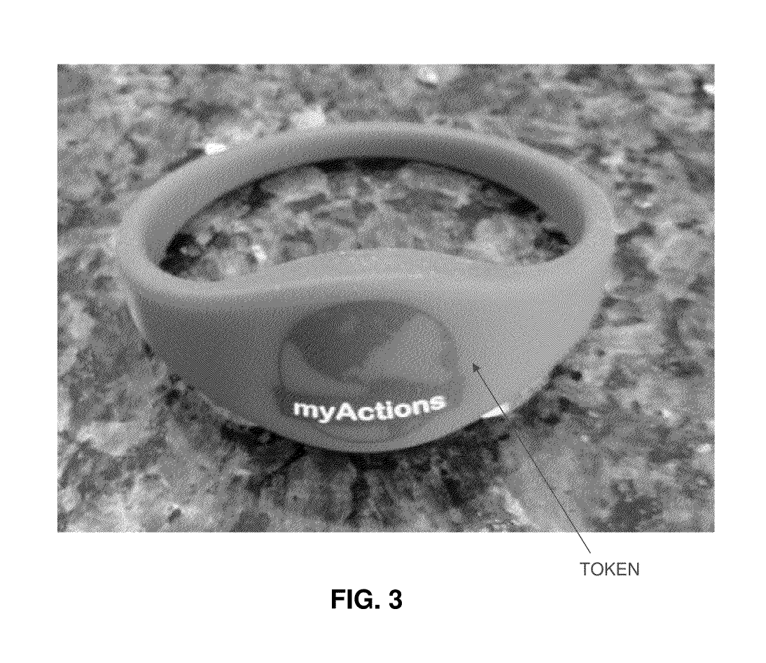

FIG. 3 shows an example of a bracelet-type token. Note that the bracelet-type token shown in FIG. 3 is intended to transmit (e.g., by wireless communication) information to a counterpart electronic receiver module at a reader.

The token can contain, but is not limited to, one or more of the following types of data: a unique token ID, a website address or identifier, a company/organization ID, and/or predefined action(s).

The unique token ID uniquely identifies the token, and can be used to identify the individual's account on a social network. This can happen when the individual registers their token with their account on the social network. Co-branded tokens may use the unique token ID to be associated with a corporate account on a social network instead of an individual's account on the social network in order to track the corporation's effect on the community (e.g., in the case that the individual wants to remain anonymous).

The website address or identifier can be used to indicate which social network the token is associated with, and hence which social network should be sent the token data from that token. Unique websites can be developed for each organization. In addition, tokens for children under 13 years of age can access sites that are COPPA (Children's Online Privacy Protection Act) compliant.

The company/organization ID can be used to identify the behaviors or actions of individuals using their tokens so the company/organization can identify and track the influence they are having on the community. This company/organization ID can be used on one, several, or all of the social network sites, depending on how the system is configured.

Tokens can be created with zero, one or more behavior(s) or action(s) programmed in the token data. If no behaviors or actions are programmed into the token and token data, the reader must be preprogrammed with a behavior or action or the reader must prompt the individual for a behavior or action to be logged on the social network. If only one behavior or action is encoded in the token data, then the reader can automatically log the behavior or action for the individual, further reducing the time necessary for the individual to input their behavior or action into the reader and hence increasing efficiency. By way of example but not limitation, the token can be encoded to log the recycling of a beverage container. In this case, presenting the token to the reader will cause the reader to log (automatically) that the individual has recycled a beverage container and to report this information to an appropriate social network. If multiple behaviors or actions are included in the token data, a menu listing these behaviors or actions may be presented to the individual by the reader so that the individual may select one or more behaviors or actions to be logged by the reader. The reader then reports the logged behaviors or actions to an appropriate social network. This is valuable for organizations trying to change certain behaviors or induce certain actions.

### 2. A Reader that Reads the Token Data

The reader can consist of any technology that can read one or more of the tokens, and store the token data for later communication with one or more hosts (e.g., the social networks) or immediately communicate the data with one or more hosts (e.g., the social networks). Thus, where the token comprises an active element which transmits token data to the reader, the reader comprises appropriate elements for receiving the token data which is being transmitted by the token (e.g., the token can comprise a wireless communication module which transmits token data to an electronic receiver module at the reader); and where the token comprises a passive element which presents token data to the reader, the reader comprises an appropriate reader module for reading the token data which is being presented by the token (e.g., the token can comprise a barcode display, a QR code display, an alphanumeric display, etc. which presents token data to an appropriate optical scanner module at the reader, or the token can comprise a passive RFID chip which presents token data to an appropriate RFID reader module at the reader, etc.). Such elements and modules will be apparent to those skilled in the art in view of the present disclosure.

The reader preferably includes means to include its location data with the token data being sent to the host (e.g., the appropriate social network). The reader location may be provided by any of several means, e.g., via GPS data, Wi-Fi triangulation, and/or a reader ID coupled with a reader location database (to show the location of the reader identified by the reader ID).

The reader may or may not have a display integrated into the reader.

Based on the data in the token and the reader's capabilities, the reader determines what user interface, if any, is presented to the individual. By way of example but not limitation, where the token has only one behavior or action encoded in the token data, the reader may provide a particular interface to the individual (or no interface at all); and where the token has zero or multiple behaviors or actions encoded in the token data, the reader may provide a different interface to the individual (e.g., a display for allowing the individual to select a particular behavior or action to be logged by the reader).

The reader may be running a local software program or a web-based program.

The reader may also be configured to receive data manually input by the individual if the individual so chooses, or if the individual does not have a token, or by a human attendant to help the individual enter data, etc.

It is also possible to use a cellular telephone (e.g., a smartphone) as the reader. This can be advantageous in situations where the individual is at a relatively individualized or isolated location (e.g., at their home) and wish to log a behavior or action, e.g., turning off a light to save energy.

Examples of readers include, but are not limited to:

1. Tablets with NFC/RFID (Near Field Communications/Radio Frequency Identification) capabilities, Bluetooth, cameras or other means of reading the tokens.

2. Cellular telephones with NFC/RFID capabilities, Bluetooth, cameras or other means of reading the tokens.

3. Hardware units specifically designed to read the tokens (e.g., a kiosk provided with NFC/RFID capabilities, Bluetooth, cameras or other means of reading the tokens).

### 3. A Communication Scheme for the Reader to Communicate to a Host System or Host Systems, One-Way or Bi-Directionally

The reader can connect to the host or hosts (e.g., a social network or social networks) in a variety of ways, including but not limited to, using the Internet or other network via wired local area networks, Wi-Fi or other wireless communications.

The token data transmitted from the reader to the host or hosts can consist of, but is not limited to, the token ID, one or more behaviors or actions, and additional information about the behavior or action (including but not limited to text, values, pictures, comments, etc.). The data transmitted from the reader to the host or hosts may also include reader location data and/or reader ID data (for correlation with a reader location database, so as to show the location of the reader), etc.

The host system can be set up as one large database that all readers communicate with directly, or several different databases that all readers communicate with (either directly or indirectly). Several companies or organizations may want to have their own database on a separate host.

The reader can be set up to work only with a specific host or to work with all hosts.

Reader configurations include, but are not limited to, the following:

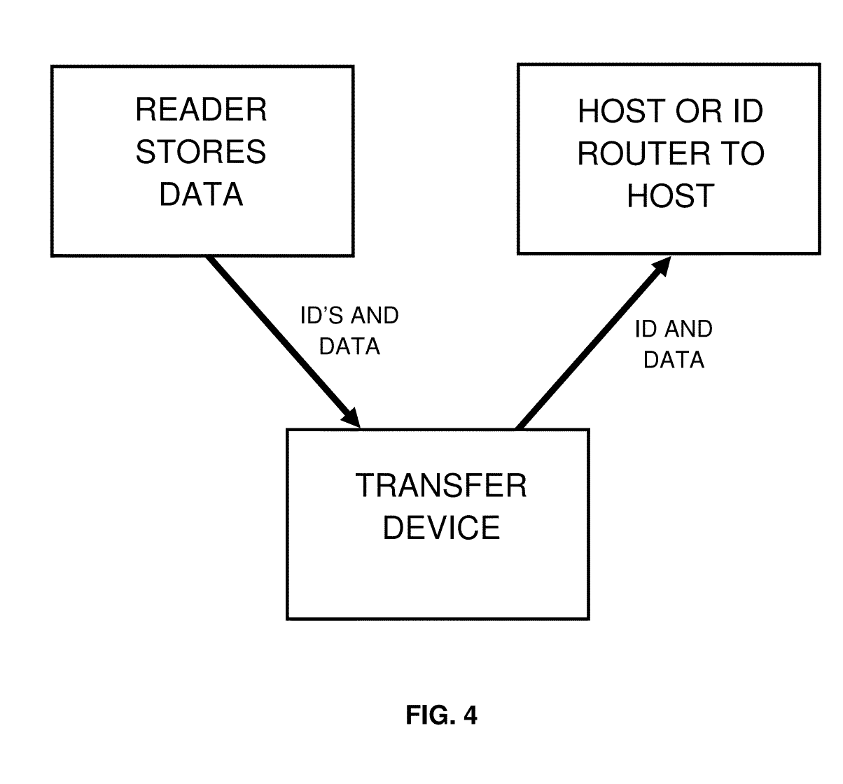

A. The reader can store the token data locally on the reader until the token data is collected and sent to the host. See FIG. 4.

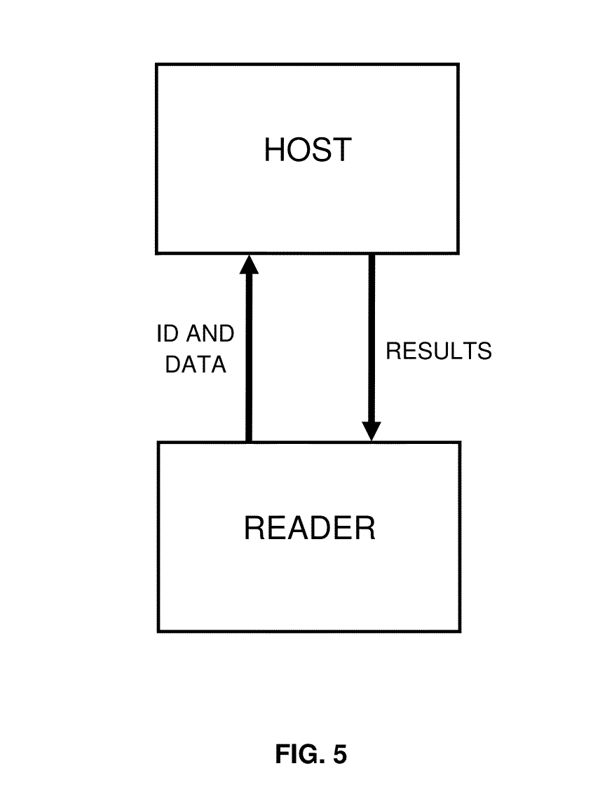

B. The reader can communicate directly to the host and the host can, optionally, communicate directly to the reader. See FIG. 5.

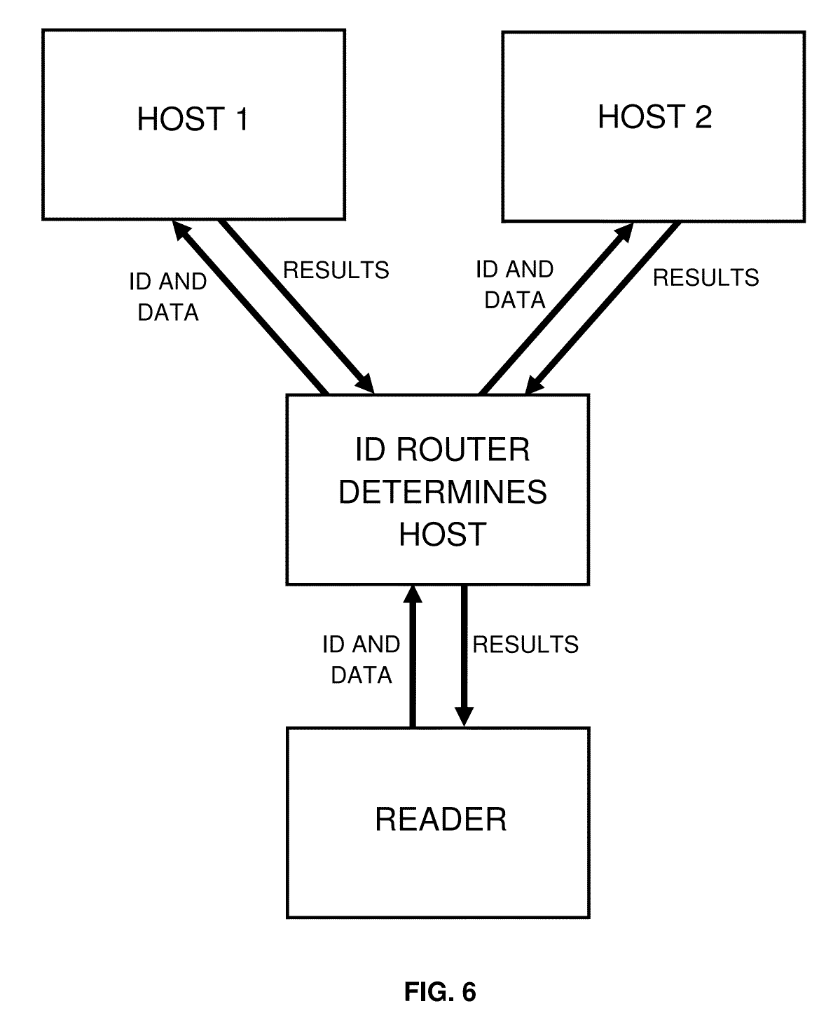

C. The reader can communicate to a router that can use the token ID/data to direct the information to the appropriate host. The host can, optionally, communicate to the reader through the router. See FIG. 6.

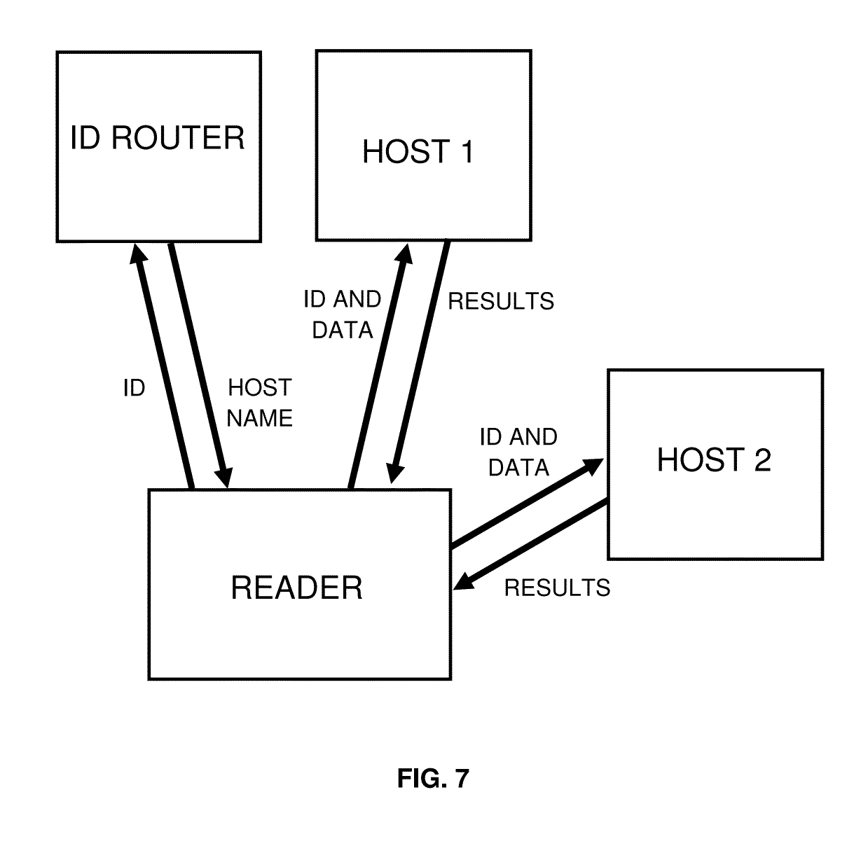

D. The reader can communicate to the router, which uses the token ID/data to reply to the reader to tell the reader which host to communicate with. See FIG. 7.

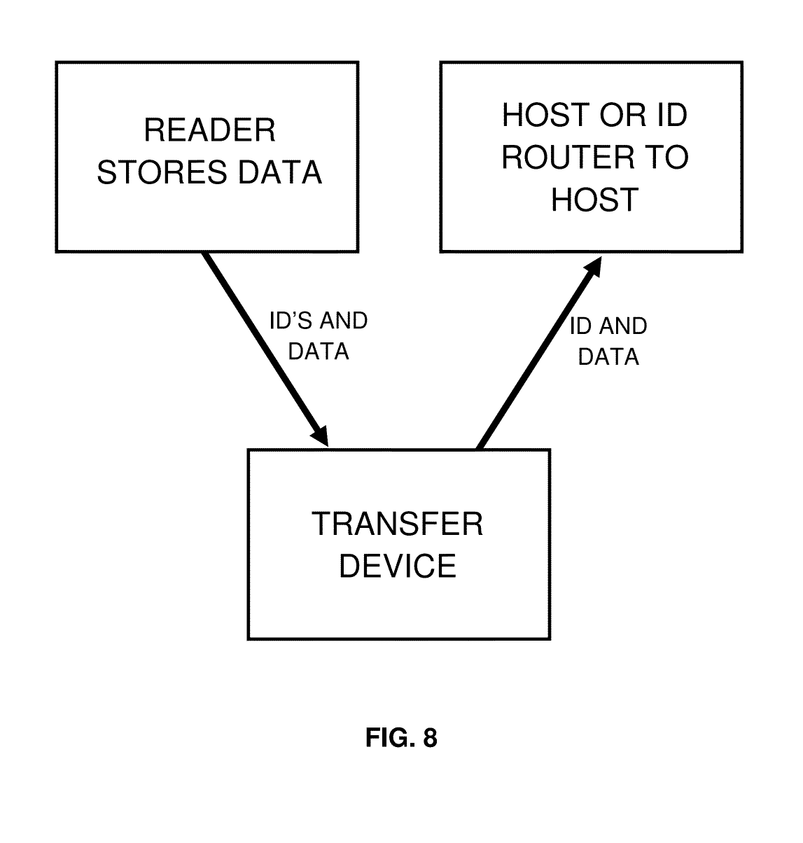

E. The reader can store the token data, and a data transfer device can read the token data from the reader at key times or at the end of the day and the data transfer device can then transfer the data to the host. See FIG. 8.

### 4. Feedback Provided at the Reader, on a Remote Display, on a Website, or by Other Means

Feedback is preferably provided to the individual, and to others, in response to the individual sharing their behaviors or actions on a social network (i.e., via a token, reader and communication scheme). Feedback can be provided to the individual, and to others, in a variety of ways which include, but are not limited to, the following:

A. Feedback can be provided to the individual or others by an electronic screen or other display technology incorporated in the reader.

B. Feedback can be provided to the individual or others at the time of reading a token, at a later time, or when a certain goal has been achieved.

C. Feedback can be provided to the individual or others by a separate display, text message, E-mail, or other means, including but not limited to, cellular telephones, so-called “smartwatches” or other wearable technologies.

D. Feedback can be displayed to individuals and others on strategically placed electronic billboards. The placement of these electronic billboards serves to reinforce the behaviors or actions of the individual, as well as to get others interested in participating and improving their own behaviors and actions.

E. Feedback can be provided to the individual when the individual logs into their personal account on the host system (e.g., the social network).

Feedback can include a variety of information, including but not limited to, the behaviors or actions performed by the individual, the impact of those behaviors or actions for the organization, the impact of those behaviors or actions for the environment, the impact of those behaviors or actions for the community, the total impact of everyone's behaviors or actions, suggestions to the individuals on how to improve their behavior in the future, etc.

Other feedback possibilities include using the token to activate informational devices at the organization for delivering information (e.g., educational information) to the individual, either on a reader or on a screen in the vicinity of the reader. This information can increase in depth (i.e., content) if the individual repeatedly scans their token at the reader. This learning action may or may not create an entry to the social network and can be used to improve the effectiveness of the feedback in the future.

Another feedback possibility allows the individual to put together a diary of their behaviors or actions, for example, to create a diary of their day at the zoo showing the environmental/social actions which they did as well as the sites they saw and what they learned.

### Exemplary Embodiment

One exemplary embodiment, but by no means the only way to implement this invention, is to use a token which comprises a bracelet, a badge (supported on a neck lanyard or pocket/belt clip, etc.), etc. having RFID/NFC or wireless capabilities which supplies token data to the reader, and a reader which comprises a tablet with RFID/NFC capabilities that can connect to the Internet via local area network, Wi-Fi or other wireless communications so as to supply the token data to the social network. The internal antenna of the tablet can be used as is, however, since the antenna is typically on the back of the tablet it is inconvenient to use the tablet in a stand since the signal cannot pass from the front of the tablet (which is the portion typically presented to the individual) to the back of the tablet (where the antenna is located). Therefore, in one preferred form of the invention, the tablet may be modified to include an external antenna to allow more convenient placement of the RFID/NFC elements. Note that where wireless (e.g., Bluetooth) communications are used, this is less of a concern.

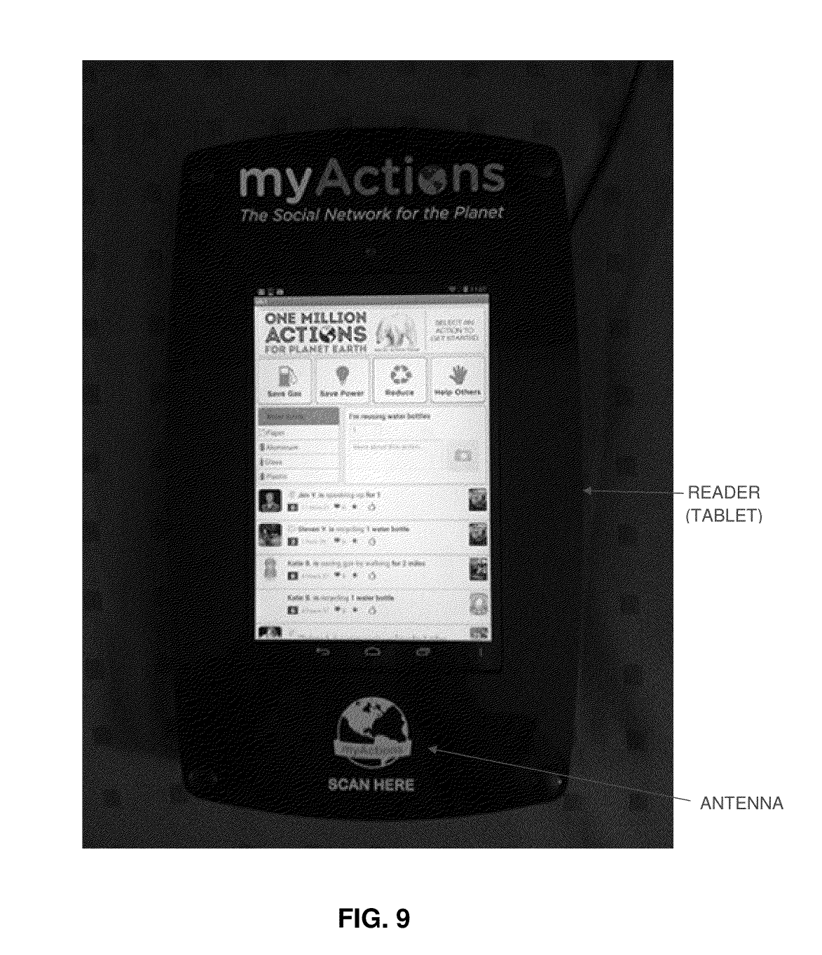

FIG. 9 is an image of an exemplary tablet reader that has been modified with an external antenna providing the ability to scan a RFID token at the “Scan Here” location on the tablet.

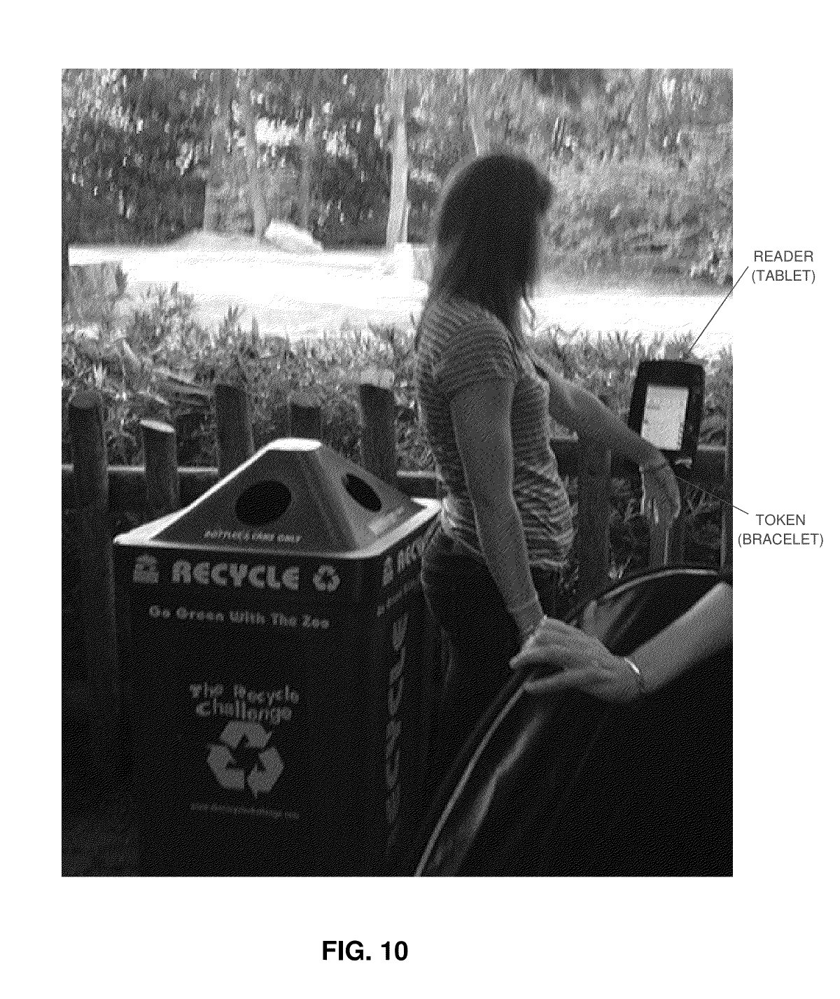

FIG. 10 shows an individual scanning a bracelet-type token near a recycling bin.

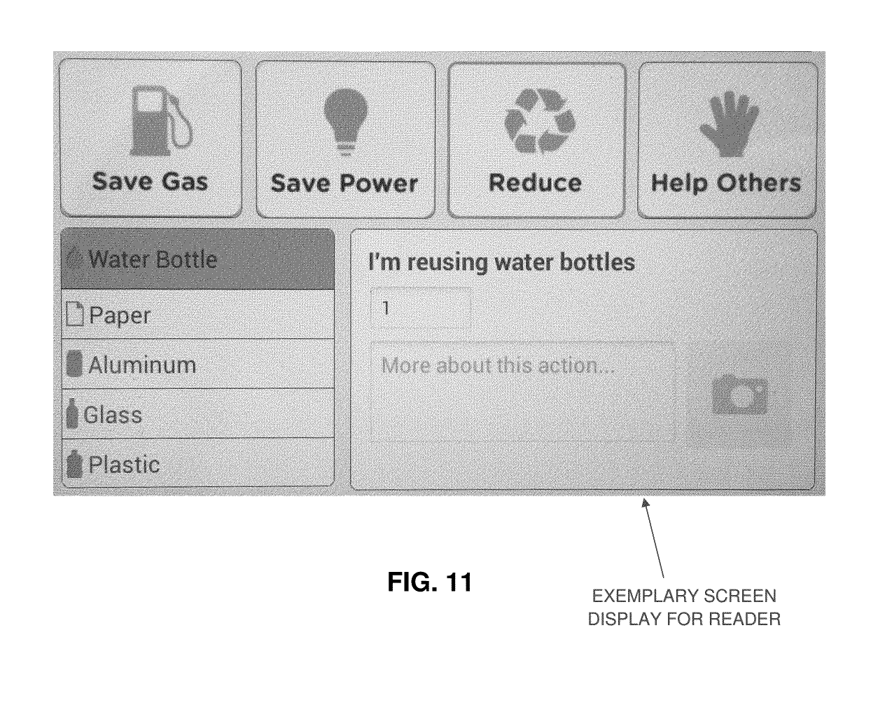

FIG. 11 is a close-up of an exemplary user interface showing four categories (Save Gas, Save Power, Reduce, and Help Others), each with a choice of five (5) behaviors or actions on the left and a data input section on the right. This is not the sole presentation of user interface for the reader, just one possibility for the user interface of the reader where more than one behavior or action is programmed in the token data.

By way of further example but not limitation, an individual may purchase or be given a token. The first time the individual uses the token, the system may ask the individual to register the token and create an account so that behaviors or actions logged by the token/reader can be uploaded to an appropriate social network. Another possibility is the system keeps track of the behaviors or actions created by the unregistered token until it is subsequently registered (whereupon the behaviors or actions logged by the token/reader can be uploaded to an appropriate social network). The token may be used at any of the readers in the community that work with the social network, making it quick and easy for the individual to enter their behaviors or actions into the social network.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A system for allowing an individual to share at least one behavior or action on a social network, said system comprising:
a token comprising token data relating to the identification of the token and the social network so that at least one behavior or action can be shared on the social network; and
a reader for receiving said token data from said token and for transferring said token data to a social network.

2. A system according to claim 1 wherein said token comprises at least one from the group consisting of a bracelet and a badge.

3. A system according to claim 2 wherein said badge is supported on at least one from the group consisting of a neck lanyard and a pocket/belt clip.

4. A system according to claim 1 wherein said token comprises an active element which transmits said token data to said reader.

5. A system according to claim 4 wherein said active element comprises at least one from the group consisting of an RFID (Radio Frequency Identification) device and another wireless communication device.

6. A system according to claim 5 wherein said another wireless communication device comprises a Bluetooth device.

7. A system according to claim 4 wherein said reader comprises a wireless communication module for receiving said token data from said active element of said token.

8. A system according to claim 1 wherein said token comprises a passive element which presents said token data to said reader.

9. A system according to claim 8 wherein said passive element comprises at least one from the group consisting of a barcode, a QR code, an alphanumeric display and a passive RFID chip.

10. A system according to claim 9 wherein said reader comprises at least one from the group consisting of an optical scanning module and a passive RFID reader module.

11. A system according to claim 1 wherein said reader comprises a display.

12. A system according to claim 11 wherein said reader comprises one from the group consisting of a tablet, a kiosk and a smartphone.

13. A system according to claim 1 wherein said reader comprises location data for indicating the physical location of said reader, and further wherein said reader transfers said location data to a social network along with said token data.

14. A system according to claim 13 wherein said location data of said reader is determined via at least one from the group consisting of GPS data, Wi-Fi triangulation and a reader ID coupled with a reader location database which shows the location of said reader identified by said reader ID.

15. A system according to claim 1 wherein said reader communicates with a social network via at least one from the group consisting of a local area network and the Internet.

16. A system according to claim 1 wherein said token data comprises:
a token ID for identifying said token; and
a social network ID for identifying a social network which is to receive said token data.

17. A system according to claim 16 wherein said social network ID is a website address.

18. A system according to claim 16 wherein said token data further comprises zero, one, or multiple behaviors or actions which are to be shared on a social network.

19. A system according to claim 18 wherein said zero, one or multiple behaviors or actions comprises at least one from the group consisting of recycling an object or material, carpooling, saving energy, reducing energy consumption, reusing an object or material, reducing use or waste, helping others, volunteering, mentoring, complying with medical prescriptions, following up on physical therapy, exercising, making healthier food choices, donating, sharing information, signing petitions, organizing or attending benefit events for a cause, and recognizing other individuals' good behaviors and actions.

20. A system according to claim 18 wherein said zero, one or multiple behaviors or actions comprises zero or a plurality of behaviors or actions, and further wherein said reader provides the individual with a list of said plurality of behaviors or actions to select from.

21. A method for allowing an individual to share at least one behavior or action on a social network, said method comprising:
providing a system comprising:
a token comprising token data relating to identification of the token and social network so that at least one behavior or action can be shared on a social network; and
a reader for receiving said token data from said token and for transferring said token data to a social network;
performing at least one behavior or action by the individual;
presenting the token to the reader so that the token data is received by the reader; and
transferring said token data from the reader to a social network.
